(19) United States
(12) Patent Application Publication
(10) Pub. No.: US 2018/0347978 A1
(43) Pub. Date: Dec. 6, 2018

(54) SYSTEM AND METHOD OF PHOTOGRAMMETRY

(71) Applicant: Michael David SÁNCHEZ, Alexandria, VA (US)

(72) Inventor: Michael David SÁNCHEZ, Alexandria, VA (US)

(21) Appl. No.: 15/611,011

(22) Filed: Jun. 1, 2017

(51) Int. Cl. G01C 11/02; G01C 11/04; G01B 11/25

(52) U.S. Cl. CPC G01C 11/02; G01B 11/25; G01C 11/04

(57) ABSTRACT

A method and system of photogrammetry. Such a system and method utilize a light detection and ranging system with one or more emitters and a detector array, in simultaneous combination with an imaging camera to generate the 3D reconstruction. By combining multiple photographs and range measurements taken from different directions and locations, a three dimensional representation of the volume/objects is created.

### BACKGROUND

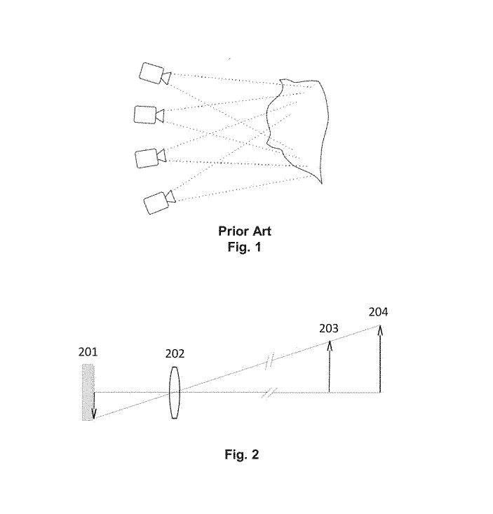

Photogrammetry is the practice of finding common reference points in images taken from different angles as shown in FIG. 1, then using a process of triangulation to determine the 3 dimensional location of those points in space.

Photogrammetry cannot provide absolute distance measurement without external aids. Due to the ambiguity between range and object size in photogrammetry, the scale of the 3D reconstruction must be calibrated through the use of control points or scale objects, for which the 3D location/size is independently measured. As shown in FIG. 2, a first distant object 203 and a second distant object 204 could form an equivalent image via an imaging lens 202 at an image plane 201 of an imaging system even though they are at a different distance. Thus, in conventional photogrammetry, the absolute scale of images cannot be determined without the use of external aids unless the range and external orientation of the camera is known. Therefore, accurately determining the range of the camera from an object is paramount to generating an accurate 3D solution.

The practice of photogrammetry is additionally limited by the need for image features that can be uniquely cross-correlated with other images. Consequently, these methods may exhibit degraded accuracy or failure to complete a measurement in cases where such features do not exist. Examples may include objects and areas with low contrast, periodic structure, or fine, random structure (such as flat vegetated areas) pose challenges for these methods.

### SUMMARY

According to at least one exemplary embodiment, a method and a system of photogrammetry may be described. Such a method and system may be able to utilize a light detection and ranging system with one or more emitters and a detector array, in simultaneous combination with an imaging camera to generate the 3D reconstruction.

Such a system of photogrammetry may include: a light source that generates a light beam; an optical projection system that projects the light beam and forming one or more of spots on an object surface; at least one detector array that detects at least one of the spots that are reflected from the object surface in order to measure the range to at least one of the plurality of spots from the time of flight of the light beam to a position of the spot on the object surface; at least one of imaging cameras capturing a plurality of images of the object surface with at least one of the projected spots; and a digital processing system measuring the ranges of the spots and processing a three dimensional reconstruction of the object surface from the measured ranges of the spots and images of the object surface that may be captured with the projected spots.

A system of photogrammetry may be further described in another exemplary embodiment. Here, the photogrammetry system can include: a light source generating a light beam; an optical projection system projecting the light and forming a plurality of patterns on the object surface; at least one of imaging cameras capturing a plurality of images of the object surface with at least one of the projected patterns; and a digital processing system calibrating scales of the images captured together with the patterns and processing a three dimensional reconstruction of the object surface from the images of the object surface and the calibrated scales of the images. Also, in the photogrammetry system, the image of the object surface and the pattern projected on the object surface reach a focal plane array of the imaging camera after passing an objective lens, and the pattern is projected on the object surface after passing at least one of an objective lens and an output window that is independent from the objective lens.

Another exemplary embodiment can describe a method of photogrammetry. The method may include: generating a light beam by a light source; projecting, by an optical projection system, the light beam to form one or more spots on an object surface; detecting, by at least one of detector arrays, at least one of the spots that is reflected from the object surface in order to measure at least one of ranges of the plurality of spots from the time of flight of the light beam to a position of the spot on the object surface; capturing, by at least one of imaging cameras, a plurality of images of the object surface with at least one of the projected spots; and measuring, by a digital processing system, the ranges of the spots and processing a three dimensional reconstruction of the object surface from the measured ranges of the spots and images of the object surface that are captured with the projected spots.

Still another exemplary embodiment can describe a method of photogrammetry. The method can include: generating a light beam by a light; projecting, by an optical projection system, the light and forming a plurality of patterns on the object surface; capturing, by at least one imaging camera, a plurality of images of the object surface with at least one of the projected patterns; calibrating, by a digital processing system, a scale of the image captured together with the patterns; and processing, by a digital processing system, a three dimensional reconstruction of the object surface from the images of the object surface and the calibrated scales of the images. Also, in the method of photogrammetry the image of the object surface and the pattern projected on the object surface reach a focal plane array of the imaging cameras after passing an objective lens, and the patterns are projected on the object surface after passing at least one of the objective lens and an output window that is independent from the objective lens.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

Exemplary FIG. 1 may show a conventional photogrammetry system;

Exemplary FIG. 2 may illustrate the range or object size ambiguity in a conventional photogrammetry system;

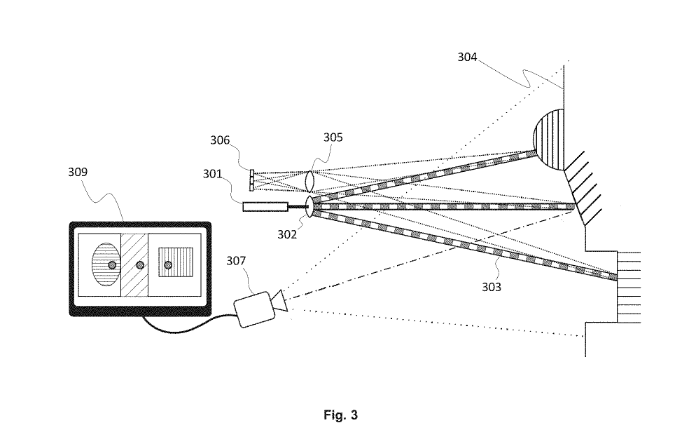

Exemplary FIG. 3 may show a light detection and ranging enhanced photogrammetry system according to an exemplary embodiment;

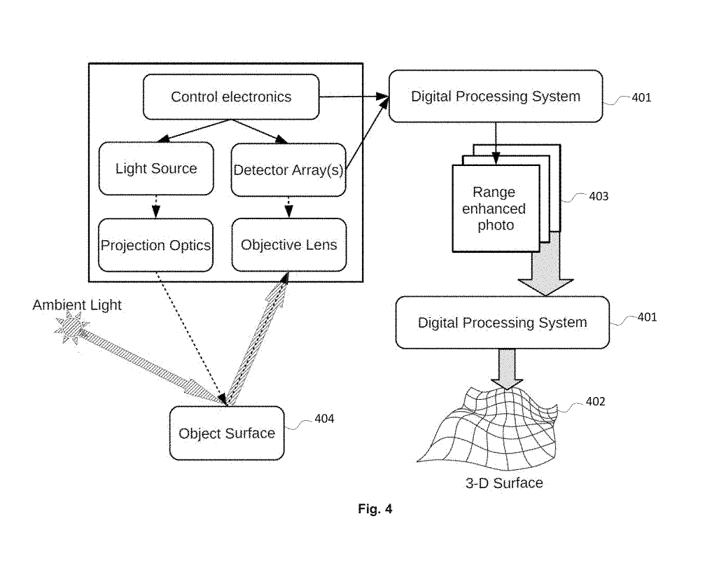

Exemplary FIG. 4 may show a block diagram of a system for light detection and ranging enhanced photogrammetry according to an exemplary embodiment;

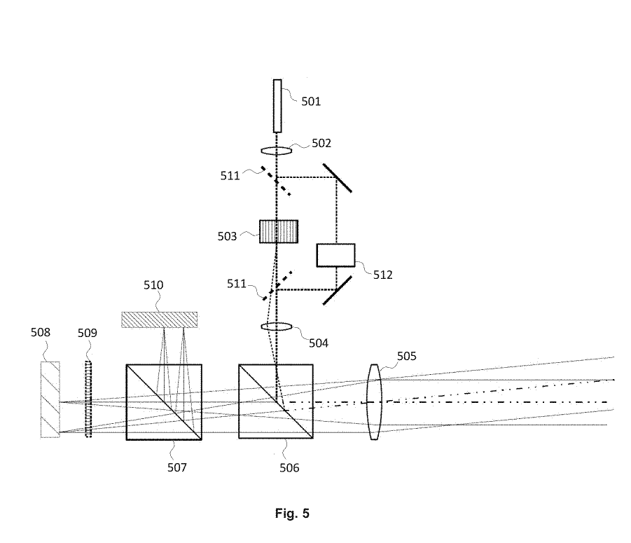

Exemplary FIG. 5 may illustrate a monostatic optical architecture according to an exemplary embodiment;

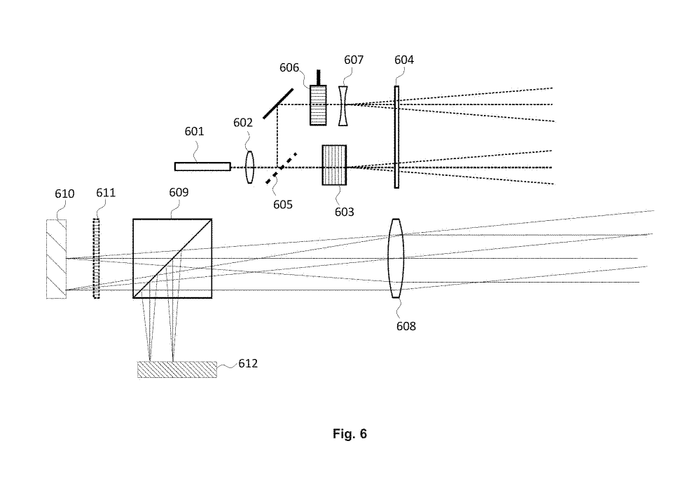

Exemplary FIG. 6 may illustrate a bistatic optical architecture according to another exemplary embodiment;

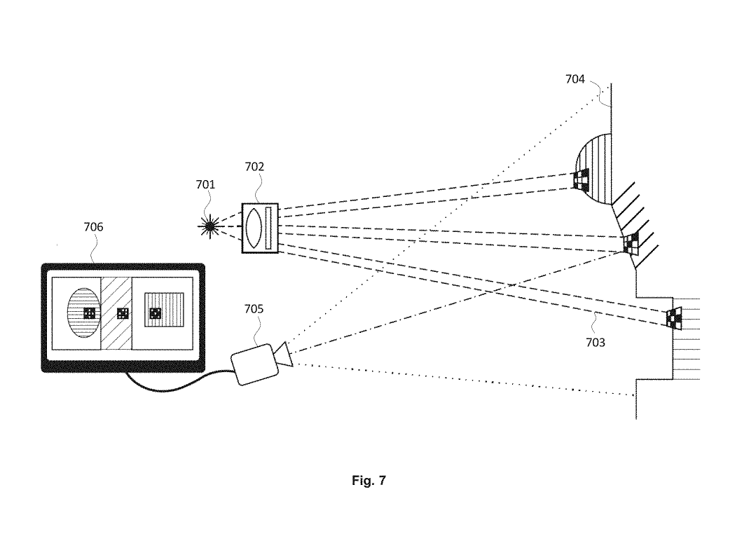

Exemplary FIG. 7 may show a structured light enhanced photogrammetry system according to another exemplary embodiment; and

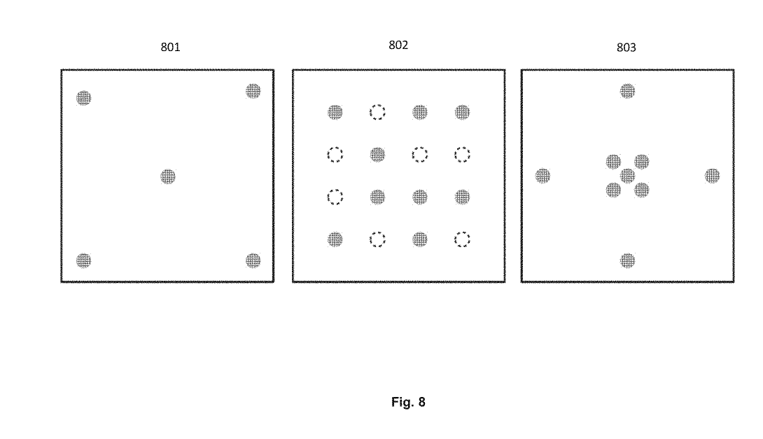

Exemplary FIG. 8 may show patterns of spots according to an exemplary embodiment.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring to the Figures generally, a method and system for photogrammetry may be disclosed. According to an exemplary embodiment, such a system may relate generally to the task of creating a 3-dimensional measurement of an object, objects, and/or a volume of space containing many objects. More specifically, the system may relate to utilizing a light detection and ranging (LIDAR) system with one or more emitters and a detector array, in simultaneous combination with an imaging camera to generate the 3D reconstruction. According to an exemplary embodiment, by combining multiple photographs and range measurements taken from different directions and locations, a three dimensional representation of the volume/objects can be created.

According to an exemplary embodiment, a method and system for light detection and ranging enhanced photogrammetry may generate photographs which are enhanced by a sparse array of range measurements from a LIDAR sensor. Also, in an exemplary embodiment, the points illuminated by the LIDAR may be projected in a calibrated pattern which are visible on the photograph. The enhanced photograph may be processed in a computer with the range measurements to calibrate the scale of the photograph and precisely measure the range and orientation of the camera to the external scene. Furthermore, a series of such photographs may be used to create three-dimensional measurement of an object or volume under inspection. Also, according to an exemplary embodiment, the light source may illuminate selected areas of the object, and so may be used to complete a surface measurement without gaps.

Turning now to exemplary FIG. 3, an exemplary embodiment of a light detection and ranging enhanced photogrammetry system may be provided. According to an exemplary embodiment, the light source 301 may generate modulated/pulsed light beam 303 and project this beam via projection optics 302 forming a known, sparse distribution of spots on object surface 304 (shown in cross-section profile). Also, in an exemplary embodiment, LIDAR detector array 306 may detect the reflected LIDAR spots via LIDAR receiver objective lens 305 so that the time of flight to the object 304 may be measured. The objects may be captured together with the projected LIDAR spots by the photogrammetry camera 307. As a result, the photogrammetry camera view 309 may be represented with the projected LIDAR spots visible in the image.

Referring still to FIG. 3, according to an exemplary embodiment, LIDAR measurements may be used to measure the 3D location of a sparse set of object points. Furthermore, the LIDAR system may utilize a wavelength that is visible to the photographic camera (307: photogrammetry camera) so the measured points are simultaneously captured in the 2-D images 309. Also, in an exemplary embodiment, the measurements of range and the observed positions of the illuminated spots in the image 309 may be used in processing the 3D reconstruction of the object 304. Accordingly, such a LIDAR enhanced photogrammetry system may provide several benefits: The external orientation of the camera can be determined for each image taken; the image scale can be calibrated based on the known projection pattern of the LIDAR spots; the points measured by the LIDAR provide reference/alignment points for the combined 3-D surface reconstruction; and measurements can be completed in areas that lack image features or natural illumination; the computation of the 3-D reconstruction is simplified and the uncertainty of the solution reduced as compared to conventional photogrammetry.

Referring still to FIG. 3, according to an exemplary embodiment, a light source 301 and an optical system 302 may project a plurality of spots (>4) in a known pattern, electronics (not shown in the figure) may be included to modulate the light source, and one or more detector arrays 306 may monitor the reflected light from the object to be measured. Also, in an exemplary embodiment, a focal plane array, imaging lens system and corresponding control and readout electronics may be additionally used in imaging cameras 307 to generate an image of the object to be measured and the projected LIDAR illumination. According to an exemplary embodiment, the light source 301 and projection optics 302 are utilized to illuminate selected areas of the object where the passive image lacks sufficient features to calculate a solution. All of the features described above may be integrated into a single housing. The co-incident and aligned arrangement of the light source and sensors may eliminate the need for separate reference points, optical targets, or other external aids to co-register the LIDAR and imagery data. With such a physical characteristic, the LIDAR data may be used in solving for the camera orientation and scale with a small number of LIDAR measurements. Directly measuring the position of the LIDAR spots on the object surface may provide a solution for the camera external orientation.

Turning now to exemplary FIG. 4, FIG. 4 may show a block diagram of a system for light detection and ranging enhanced photogrammetry. According to an exemplary embodiment, a digital processing system 401 may be used to record the images and range data, computes the external orientation of each frame, calibrates the scale of each image, and determines the 3-D position of the LIDAR points. Also, in an exemplary embodiment, the digital processing system 401 may include memory and computing resources to compute the 3-D reconstruction 402 of the object 404 from multiple images 403 taken from points around or within the object of interest and enhanced with the range data.

Turning now to exemplary FIG. 5, a monostatic optical architecture of light detection and ranging enhanced photogrammetry may be illustrated according to an exemplary embodiment. In exemplary FIG. 5, ray paths may indicate the chief ray and marginal rays. Dotted lines may show the path of the outgoing TX path light (chief ray only). Solid lines may show the incoming light paths. Dash-dotted lines may show the bidirectional chief rays of the optical fields illustrated. According to an exemplary embodiment, the LIDAR sensor 508 and the imaging sensor 510 may utilize a common optical aperture (the objective lens 505). The two incoming optical paths (the optical paths of the image of the object and the LIDAR spot) may pass through the beamsplitter 507 as well as be reflected from the beamsplitter 507 to reach both the LIDAR sensor 508 and the imaging sensor 510. According to an exemplary embodiment, the LIDAR sensor 508 may receive the LIDAR spot selectively by the beamsplitter 507 which is wavelength selective or by an optional wavelength selective filter 509. Also, in an exemplary embodiment, the one outgoing optical path and two incoming optical paths may be separated by another beamsplitter 506. Either partially reflective or polarization selective beamsplitter coatings may be used in the beamsplitters (506: polarizing or neutral density and 507: neutral density or wavelength selective). In an exemplary embodiment, additional optics (collimating optic 502, projection optics 503, relay lens(es) 504 and alternate optics for illumination 512) may be used in the transmit path to form the projected light pattern. For example, the optics 502 may collimate the light source 501 output beam, then direct the beam through the projection optics 503. The projection optics 503 may create a multitude of beams and which are still collimated but travel in different angular directions. Also, relay lens (or lens group) 504 may be then used to couple these beams to the objective lens 505 as a telescopic relay pair.

Referring still to FIG. 5, according to an exemplary embodiment, actuated mirrors 511 may further be used in the transmit section to create an alternative path which bypasses the projection optics 503. Such an alternative path may contain additional optical elements 512 which are used when the system is taking measurements on areas of the object where the ambient illumination is insufficient or surface conditions are unfavorable for image feature detection.

Turning now to exemplary FIG. 6, a bistatic optical architecture may be illustrated according to another exemplary embodiment. In exemplary FIG. 6, ray paths may indicate the central optical path and one off-axis path. Dotted lines may show the path of the outgoing TX path light (chief ray only). Solid lines may show the incoming light paths. Referring to FIG. 6, according to an exemplary embodiment, the light source 601 may be transmitted through an optical path (collimating optic 602, projection optics 603 and output window 604) that is separate from the receive path objective lens 608. The transmit path (602, 603 and 604) may be located adjacent to, or inset within, the receive path (objective lens 608, beamsplitter 609, LIDAR receiver array 610, optional wavelength selective filter 611 and imaging detector array 612). Within the transmit path, the optics required may be identical to the monostatic case of FIG. 5. The collimating lens 602 may be used to generate a single beam from the light source 601, which is then passed through a projection system 603 to generate a multitude of outgoing beams. To create the alternate illumination path, moveable mirrors 605 may be used in the same manner as in the monostatic case. Alternately, a fixed beam splitter (not shown in figure), additional output lens 607 and shutter mechanism 606 may be used to control the light path through one of the two illumination paths. According to another exemplary embodiment, a second light source (not shown in figure) may be used instead of the movable mirror 605 or shutters 606, and the light source may be modulated electronically.

Referring still to FIG. 6, in the receive path of bistatic architecture, a partially reflective, wavelength or polarization selective beamsplitter 609 may be used to direct some of the light to the two sensor arrays (LIDAR receiver array 610 and imaging detector array 612) like the monostatic architecture. Both sensor arrays (610 and 612) may be placed at the focal plane of the objective lens 608. According to an exemplary embodiment, the LIDAR sensor array 610 may be installed to match the spacing and orientation of the projected light pattern so that each detector in this array may be matched to a single projected spot direction. Also, in an exemplary embodiment, a wavelength selective filter 611 may be used in front of the LIDAR receiver array 610.

The exemplary optical system architectures described above may have several options for components described. The light source may be a laser or an LED, operating in any wavelength visible to the imaging sensor. Typical wavelength bands for which light sources and detectors are available include 400 nm-700 nm (visible), 700 nm-1000 nm (near-IR), 1200-2200 nm (shortwave infrared), and 2.2-12 μm (infrared). For example, an exemplary embodiment may utilize silicon detectors and a color imaging camera with a near-IR light source. Since silicon sensors can detect light from 400 nm-1000 nm, in an exemplary embodiment, an easily interpreted picture of the scene may be produced, and the positions of the illuminated spots may still be captured.

Turning now to exemplary FIG. 7, FIG. 7 may show a structured light enhanced photogrammetry in which a structured light system is utilized instead of the LIDAR according to another exemplary embodiment. The light source 701 may generate the structured light beam 703 and project the structured light pattern via projection optics 702 forming a known, sparse pattern on object surface 704 (shown in cross-section profile). In an exemplary embodiment, the objects may be captured together with the structured light spots by the photogrammetry camera 705. The photogrammetry camera view 706 may be represented with the structured light spots visible in the image. As a result, with knowledge of the angular distribution of the pattern, the observed locations and shape of the pattern can be used to calculate the distance of the illuminated spots in the scene.

In conventional structured light methods, the illumination patterns require that most of the surface to be measured be illuminated. Comparing to the conventional structured light method, structured light enhanced photogrammetry system may resolve local range measurements in the illuminated areas and utilize the measurements in the overall method described above because the projection system 702 may produce small areas of structured light patterns. Also, structured light enhanced photogrammetry may not require a separate detector array for the range measurement functionality and only the main imaging array may be used.

According to an exemplary embodiment, a projected light pattern may be static and relatively simple. A small number of illuminated spots may be used to minimize the power required by the light source 701. In an exemplary embodiment, a diffractive optical element may be utilized to create a uniformly spaced square grid array with 4-16 spots and a corresponding detector array. The grid may be fully filled, or partially filled. In another exemplary embodiment, a pattern of spots may be used with variable spacing such that a higher density of spots is contained in the region near the optical axis of the system, with a lower density of spots at larger angles within the field-of-view. FIG. 8 may show exemplary patterns of spots. According to an exemplary embodiment, the pattern of spots may be a uniform and filled grid example with 5 spots (801). In another exemplary embodiment, the pattern of spots may be uniform and partially filled grid example with 9 spots (802: dashed lines may indicate alternative spot locations in the grid). Also, the pattern of spots may be non-uniformly spaced pattern (803: non-uniformly spaced pattern with 9 spots). Thus, a large variety of projected patterns may be utilized with little constraint. According to an exemplary embodiment, patterns which may confine illumination to a small area are preferred, and it is also preferred that illuminated areas may correspond to a single detector in the LIDAR receiver.

According to an exemplary embodiment, nominally two detector arrays may be used. One small array may be used in the LIDAR system to make the sparse set of range measurements. The other detector array may be a dense and large array to capture the entire scene and provide the detailed images for 3-D reconstruction. There may be several possible embodiments for each of these detector arrays. According to an exemplary embodiment, preferred detectors are matched to the light source wavelength and the ambient illumination of the object. In special cases, this may result in SWIR (short-wave infrared) or IR (infrared) sensitive materials being appropriate, but for the majority of situations, visible and/or NIR (near infrared) sensitive detectors may be the most economical and effective choice. Silicon photodiode arrays, CMOS arrays, and CCD sensors are well matched to many potential applications of this invention. The imaging array, in particular, may be a silicon array, using either CMOS or CCD detectors. Sensors of these types are available in color or monochrome versions, and both are preferred. In the LIDAR array, larger temporal bandwidth is required to measure the LIDAR waveform. Therefore it may be embodied as a small array of photodiodes. These photodiodes may be P-I-N, avalanche photo diode, or single-photon avalanche photodiode type detectors.

According to an exemplary embodiment, synchronized data collection of the LIDAR and image data is preferred. Referring to exemplary FIG. 4, this control function may be achieved and embodied by a microcontroller device or by a Field Programmable Gate Array (FPGA) device in the digital processing system 401. The microcontroller may accept acquisition commands (or a program prescribing a series of acquisitions) from the user via the user interface of the digital processing system 401, configure the system settings as needed (for example, camera exposure time, light power level, or modulation pattern, etc.), generate the necessary electronic triggers for synchronized transmit and receive operations, and return electronic signals which indicate a measurement has been completed. “Pre-processing” of the received signals from a single frame measurement may be performed in the microcontroller segment or the larger digital image processing system. Pre-processing includes operations necessary to reduce electronic signals to dimensional values which can be stored in memory for further processing and later use. According to an exemplary embodiment, optional operations may further be included: noise filtering and background subtraction (both LIDAR and image data), pulse train correlation for detection and ranging, image enhancement operations (for example, uniformity correction, contrast enhancement and/or frame stacking for increased dynamic range), spot centroid determination and feature detection, determination of the external camera orientation, non-linear image transformations to correct for lens distortion, and determination of image scale. In an exemplary embodiment, pre-processing operations may be conducted in the same computing hardware that synchronizes the data acquisition in order to minimize the volume of digital data as quickly as possible. According to an exemplary embodiment, the output of this step after a single acquisition event may be a single frame, scale-correct (a.k.a “ortho-rectified”) image, corresponding range measurements, camera orientation solution and meta data recording the acquisition parameters.

According to an exemplary embodiment, these data may be transmitted to the next step in the digital image processing system, which may be embodied as a software program on a personal computer or computer server. In this next step the software may jointly process a series of ortho-rectified images and the corresponding sparse LIDAR points to reconstruct the three-dimensional surface of the object under inspection.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system of photogrammetry comprising:
a light source generating a light beam;
an optical projection system projecting the light beam and forming a plurality of spots on an object surface;
at least one detector array detecting at least one of the spots that is reflected from the object surface in order to measure at least one of ranges of the plurality of spots from the time of flight of the light beam to the position of the spot on the object surface;
at least one imaging camera capturing a plurality of images of the object surface with at least one of the projected spots; and
a digital processing system measuring the ranges of the spots and processing a three dimensional reconstruction of the object surface from the measured ranges of the spots and the images of the object surface that are captured with the projected spots.

2. The system of claim 1, wherein the light beam is at least one of a modulated light beam and a pulsed light beam, and a wavelength of the light beam is visible to the imaging camera.

3. The system of claim 1, wherein the digital processing system further comprises:
a memory storing the images of the object surface, the ranges of the spots; and
at least one processor calculating the range of the spots, determining a three dimensional position of the spots, and computing the three dimensional reconstruction of the object surface from the images.

4. The system of claim 1, wherein a focal plane array of the imaging camera receives the image of the object surface and the spots that are directed by a beamsplitter, the detector array receives the spots that are directed by the beamsplitter, and the beamsplitter is at least one of partially reflective, polarization selective and wavelength selective.

5. The system of claim 1, wherein the light beam from the light source is projected on the object surface after being directed by a beamsplitter, the image of the object surface and the spot reach a focal plane array of the imaging camera and the detector array after redirection by the beamsplitter, and the beamsplitter is at least one of partially reflective, polarization selective and wavelength selective.

6. The system of claim 1, wherein the image of the object surface and the spots reach both a focal plane array of the imaging camera and the detector array after passing a common objective lens, and the light beam from the light source is projected on the object surface after passing at least one of relay lenses and the common objective lens.

7. The system of claim 1, wherein the image of the object surface and the spots reach both a focal plane array of the imaging camera and the detector array after passing an objective lens, and the light beam from the light source is projected on the object surface after passing an output window that is independent from the objective lens.

8. The system of claim 1, wherein the optical projection system further comprises:
a collimating optic that collimates the light beam;
a plurality of projection optics through which the collimated light beam is directed and, from the light beam of the light source, creates multiple light beams that travel in multiple angular directions;
an alternate illumination optics through which the light beam passes after being reflected from a movable mirror and bypassing the projection optics.

9. A system of photogrammetry comprising:
a light source generating a light beam;
an optical projection system projecting the light beam and forming a plurality of patterns on the object surface;
at least one imaging camera capturing a plurality of images of the object surface with at least one of the projected patterns; and
a digital processing system calibrating a scale of the image captured together with the patterns and processing a three dimensional reconstruction of the object surface from the images of the object surface and the calibrated scales of the images,
wherein the image of the object surface and the patterns projected on the object surface reach a focal plane array of the imaging camera after passing an objective lens, and the patterns are projected on the object surface after passing at least one of the objective lens and an output window that is independent from the objective lens.

10. A method of photogrammetry comprising:
generating a light beam by a light source;
projecting, by an optical projection system, the light beam to form a plurality of spots on an object surface;
detecting, by at least one detector array, at least one of the spots that is reflected from the object surface in order to measure at least one of ranges of the plurality of spots from the time of flight of the light beam to a position of the spot on the object surface;
capturing, by at least one imaging camera, a plurality of images of the object surface with at least one of the projected spots;
measuring, by a digital processing system, the ranges of the spots; and
processing, by a digital processing system, a three dimensional reconstruction of the object surface from the measured ranges of the spots and images of the object surface that are captured with the projected spots.

11. The method of claim 10, wherein the light beam is at least one of a modulated light beam and a pulsed light beam, and a wavelength of the light beam is visible to the image camera.

12. The method of claim 10, wherein measuring, by a digital processing system, further comprises:
storing, by a memory, the images of the object surface, the ranges of the spots; and
calculating, by at least one processor, the ranges of the spots,
determining, by the at least one processor, a three dimensional position of the spots, and
computing, by the at least one processor, the three dimensional reconstruction of the object surface from the images.

13. The method of claim 10, wherein a focal plane array of the imaging camera receives the image of the object surface and the spots that are directed by a beamsplitter, the detector array receives the spots that are directed by the beamsplitter, and the beamsplitter is at least one of partially reflective, polarization selective and wavelength selective.

14. The method of claim 10, wherein the light beam from the light source is projected on the object surface after being directed by a beamsplitter, the image of the object surface and the spots reach a focal plane array of the imaging camera and the detector array after redirection by the beamsplitter, and the beamsplitter is at least one of partially reflective, polarization selective and wavelength selective.

15. The method of claim 10, wherein the image of the object surface and the spot reach both a focal plane array of the imaging camera and the detector array after passing a common objective lens, and the light beam from the light source is projected on the object surface after passing at least one of relay lenses and the common objective lens.

16. The method of claim 10, wherein the image of the object surface and the spot reach both a focal plane array of the imaging camera and the detector array after passing an objective lens, and the light beam from the light source is projected on the object surface after passing an output window that is independent from the objective lens.

17. A method of photogrammetry comprising:
generating a light beam by a light;
projecting, by an optical projection system, the light beam and forming a plurality of patterns on the object surface;
capturing, by at least one image camera, a plurality of images of the object surface with at least one of the projected patterns;
calibrating, by a digital processing system, a scale of the image captured together with the patterns; and
processing, by a digital processing system, a three dimensional reconstruction of the object surface from the images of the object surface and the calibrated scales of the images,
wherein the image of the object surface and the patterns projected on the object surface reach a focal plane array of the imaging camera after passing an objective lens, and the patterns are projected on the object surface after passing at least one of the objective lens and an output window that is independent from the objective lens.
